(19) United States
(12) Patent Application Publication
(10) Pub. No.: US 2017/0317856 A1
(43) Pub. Date: Nov. 2, 2017

(54) METHOD FOR DETERMINING WHETHER TO DRIVE SYMBOL LEVEL INTERFERENCE CANCELLER

(71) Applicant: LG ELECTRONICS INC., Seoul (KR)

(72) Inventors: Sangwook LEE, Seoul (KR); Yoonoh YANG, Seoul (KR); Suhwan LIM, Seoul (KR); Manyoung JUNG, Seoul (KR); Jinyup HWANG, Seoul (KR)

(73) Assignee: LG ELECTRONICS INC., Seoul (KR)

(21) Appl. No.: 15/520,649

(22) PCT Filed: Oct. 22, 2015
(86) PCT No.: PCT/KR2015/011195

§ 371 Date: Apr. 20, 2017

Related U.S. Application Data
(60) Provisional application No. 62/069,330, filed on Oct. 28, 2014.

(51) Int. Cl. H04L 25/03; H04B 17/318; H04W 84/04; H04W 88/02

(52) U.S. Cl. CPC H04L 25/03006; H04W 88/02; H04B 17/318; H04W 84/045

(57) ABSTRACT

A disclosure of the present specification provides a method for determining whether to drive a symbol level interference canceller on the basis of a network support. The method comprises the steps of: determining whether to turn on the symbol level interference canceller on the basis of condition information on at least one between a serving cell and an interference cell; driving the symbol level interference canceller according to the determination; and determining whether to turn off the symbol level interference canceller, when the condition information has changed, while driving the symbol level interference canceller.

### BACKGROUND OF THE INVENTION

### Field of the Invention

The present invention relates to mobile communication.

### Related Art

3rd generation partnership project (3GPP) long term evolution (LTE) evolved from a universal mobile telecommunications system (UMTS) is introduced as the 3GPP release 8. The 3GPP LTE uses orthogonal frequency division multiple access (OFDMA) in a downlink, and uses single carrier-frequency division multiple access (SC-FDMA) in an uplink.

Such LTE may be divided into a frequency division duplex (FDD) type and a time division duplex (TDD) type.

As set forth in 3GPP TS 36.211 V10.4.0, the physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

Meanwhile, it is expected that small cells with small cell coverage are added to the coverage of a macrocell in a next-generation mobile communication system.

The addition of small cells may further aggravate inter-cell interference.

Due to such an interference problem, a user device may include an interference cancellation function. However, because the interference cancellation function has very large complexity, it may be inefficient to always execute interference cancellation.

### SUMMARY OF THE INVENTION

Accordingly, a disclosure of the present specification has been made in an effort to solve the aforementioned problem.

In an aspect, a method of determining whether to operate a symbol level interference canceller based on network assistance is provided. The method includes: determining whether to turn on the symbol level interference canceller based on condition information about any one of a serving cell and an interference cell; operating the symbol level interference canceller according to the determination; and determining whether to turn off the symbol level interference canceller, when the condition information is changed while operating the symbol level interference canceller.

The condition information about any one of a serving cell and an interference cell may include at least one of: condition information about receiving power from the serving cell and receiving power from the interference cell; condition information about the rank number of the interference cell; condition information about a modulation order of the interference cell; and information about a transmission mode (TM) of the serving cell and condition information about a TM of the interference cell.

The determining of whether to turn on the symbol level interference canceller may include determining to turn on the symbol level interference canceller, if receiving power from the interference cell is equal to or larger than receiving power from the serving cell by a predetermined ratio. The determining of whether to turn off the symbol level interference canceller may include determining to turn off the symbol level interference canceller, if receiving power from the interference cell is smaller than receiving power from the serving cell by a predetermined ratio.

The determining of whether to turn on the symbol level interference canceller may include determining to turn on the symbol level interference canceller, when a rank of the interference cell is 1. The determining of whether to turn off the symbol level interference canceller may include determining to turn off the symbol level interference canceller, when a rank of the interference cell is 2.

The determining of whether to turn on the symbol level interference canceller and the determining of whether to turn off the symbol level interference canceller may be performed when a modulation order of the interference cell is equal to or larger than a predetermined modulation order.

The determining of whether to turn on the symbol level interference canceller may include determining to turn on the symbol level interference canceller, when the serving cell and the interference cell equally use a CRS or DMRS based TM. The determining of whether to turn off the symbol level interference canceller may include determining to turn off the symbol level interference canceller when the serving cell uses a DMRS based TM, but when the interference cell uses a CRS based TM.

According to disclosure of this specification, even if inter-cell interference increases, a reception performance of a signal can be enhanced through interference cancellation.

### BRIEF DESCRIPTION OF THE DRAWINGS

FIG. 1 illustrates a wireless communication system.

FIG. 2 illustrates the architecture of a radio frame according to frequency division duplex (FDD) of 3rd generation partnership project (3GPP) long term evolution (LTE).

FIG. 3 illustrates an example resource grid for one uplink or downlink slot in 3GPP LTE.

FIG. 4 illustrates the architecture of a downlink subframe.

FIG. 5 illustrates the architecture of an uplink subframe in 3GPP LTE.

FIG. 6 illustrates inter-cell interference.

FIG. 7 illustrates enhanced inter-cell interference coordination (eICIC) to address interference between base stations.

FIG. 8 illustrates an environment of a heterogeneous network including a macrocell and small cells as a potential next-generation wireless communication system.

FIG. 9 is a signal flowchart illustrating a receiving method using interference cancellation.

FIG. 10 is a diagram illustrating a structure of an interference cancellation receiver according to disclosure of this specification.

FIG. 11A is a graph comparing a performance of a NAICS receiver and a performance of a general IRC receiver, when a rank of an interference cell is 1, and FIG. 11B is a graph comparing a performance of a NAICS receiver and a performance of a general IRC receiver, when a rank of an interference cell is 2.

FIG. 12 is a graph illustrating a performance of NAICS and a performance of existing MMSE-IRC, when a serving cell uses TM9 and when an interference cell uses TM4.

FIG. 13 is a flowchart illustrating a method according to disclosure of this specification.

FIG. 14 is a block diagram illustrating a wireless communication system according to disclosure of this specification.

### DESCRIPTION OF EXEMPLARY EMBODIMENTS

Hereinafter, based on 3rd Generation Partnership Project (3GPP) long term evolution (LTE) or 3GPP LTE-advanced (LTE-A), the present invention will be applied. This is just an example, and the present invention may be applied to various wireless communication systems. Hereinafter, LTE includes LTE and/or LTE-A.

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the specification includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the specification, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

As used herein, ‘base station’ generally refers to a fixed station that communicates with a wireless device and may be denoted by other terms such as eNB (evolved-NodeB), BTS (base transceiver system), or access point.

As used herein, user equipment (UE) may be stationary or mobile, and may be denoted by other terms such as device, wireless device, terminal, MS (mobile station), UT (user terminal), SS (subscriber station), MT (mobile terminal) and etc.

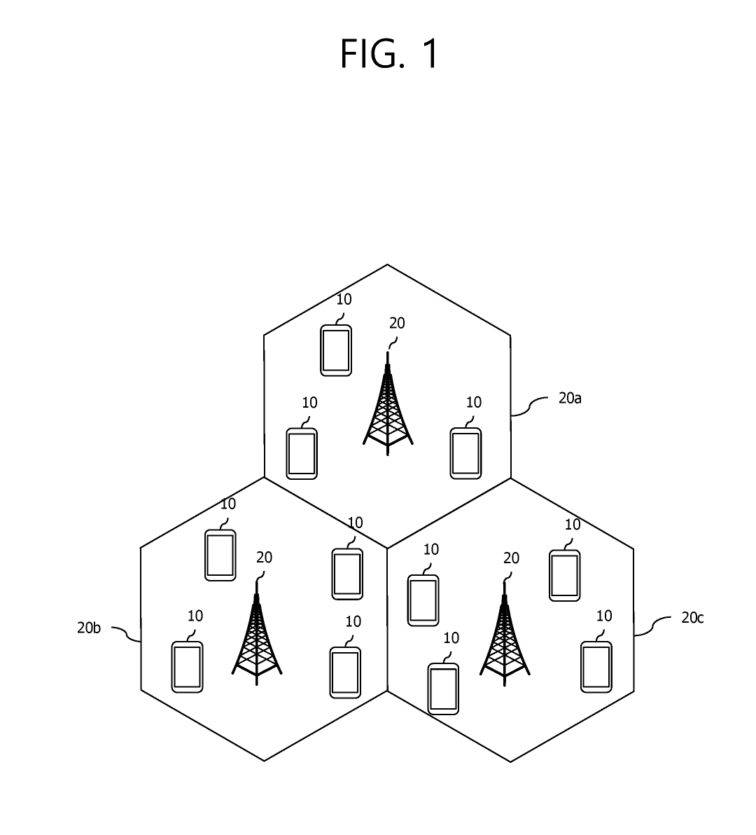

FIG. 1 Illustrates a Wireless Communication System.

Referring to FIG. 1, the wireless communication system includes at least one base station (BS) 20. Respective BSs 20 provide a communication service to particular geographical areas 20a, 20b, and 20c (which are generally called cells).

The UE generally belongs to one cell and the cell to which the terminal belongs is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the terminal 10 and an uplink means communication from the terminal 10 to the base station 20. In the downlink, a transmitter may be a part of the base station 20 and a receiver may be a part of the terminal 10. In the uplink, the transmitter may be a part of the terminal 10 and the receiver may be a part of the base station 20.

Hereinafter, the LTE system will be described in detail.

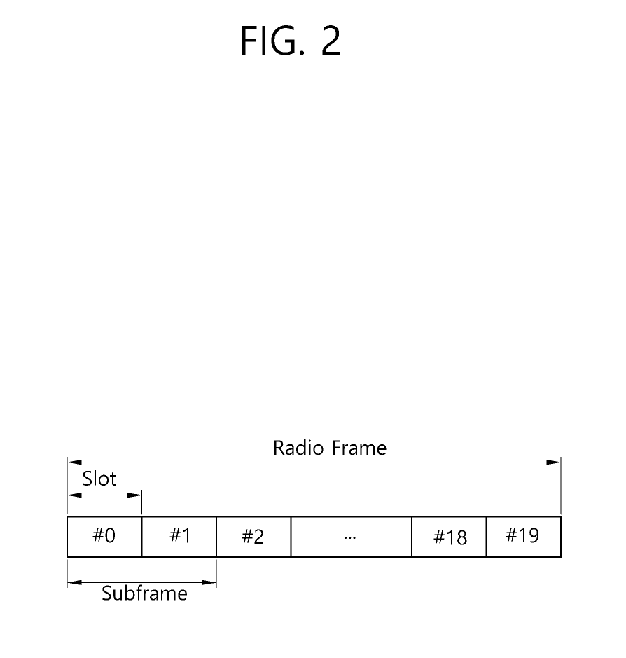

FIG. 2 Shows a Downlink Radio Frame Structure According to FDD of 3rd Generation Partnership Project (3GPP) Long Term Evolution (LTE).

The radio frame of FIG. 2 may be found in the section 5 of 3GPP TS 36.211 V10.4.0 (2011-12) “Evolved Universal Terrestrial Radio Access (E-UTRA); Physical Channels and Modulation (Release 10)”.

Referring to FIG. 2, the radio frame consists of 10 subframes. One subframe consists of two slots. Slots included in the radio frame are numbered with slot numbers 0 to 19. A time required to transmit one subframe is defined as a transmission time interval (TTI). The TTI may be a scheduling unit for data transmission. For example, one radio frame may have a length of 10 milliseconds (ms), one subframe may have a length of 1 ms, and one slot may have a length of 0.5 ms.

The structure of the radio frame is for exemplary purposes only, and thus the number of subframes included in the radio frame or the number of slots included in the subframe may change variously.

Meanwhile, one slot may include a plurality of OFDM symbols. The number of OFDM symbols included in one slot may vary depending on a cyclic prefix (CP).

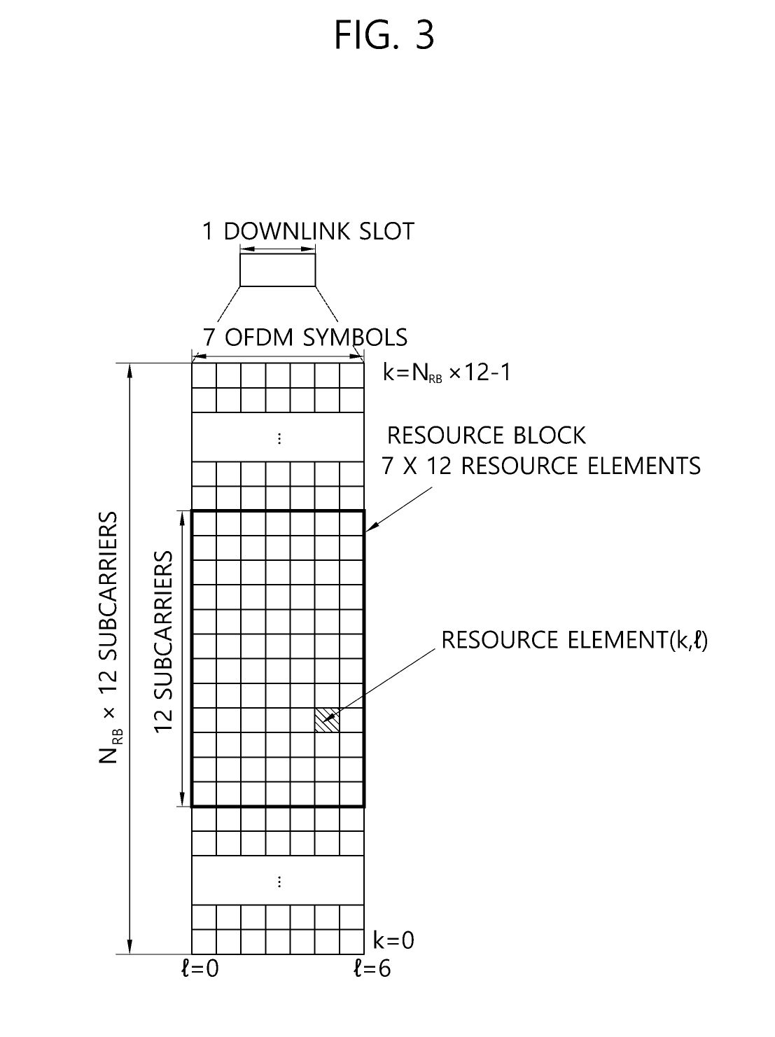

FIG. 3 Illustrates an Example Resource Grid for One Uplink or Downlink Slot in 3GPP LTE.

Referring to FIG. 3, the uplink slot includes a plurality of OFDM (orthogonal frequency division multiplexing) symbols in the time domain and NRB resource blocks (RBs) in the frequency domain. For example, in the LTE system, the number of resource blocks (RBs), i.e., NRB, may be one from 6 to 110.

Resource block (RB) is a resource allocation unit and includes a plurality of sub-carriers in one slot. For example, if one slot includes seven OFDM symbols in the time domain and the resource block includes 12 sub-carriers in the frequency domain, one resource block may include 7×12 resource elements (REs).

Meanwhile, the number of sub-carriers in one OFDM symbol may be one of 128, 256, 512, 1024, 1536, and 2048.

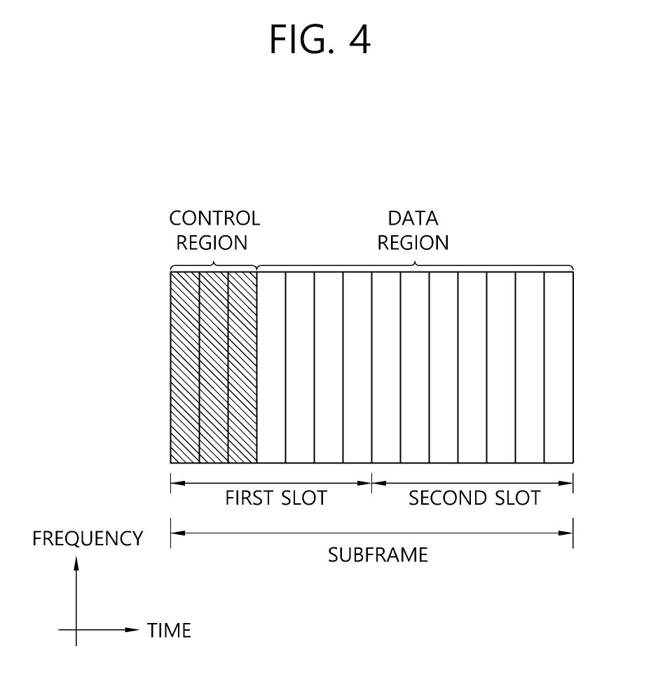

In 3GPP LTE, the resource grid for one uplink slot shown in FIG. 4 may also apply to the resource grid for the downlink slot.

FIG. 4 Illustrates the Architecture of a Downlink Sub-Frame.

In FIG. 4, assuming the normal CP, one slot includes seven OFDM symbols, by way of example.

The DL (downlink) sub-frame is split into a control region and a data region in the time domain. The control region includes up to first three OFDM symbols in the first slot of the sub-frame. However, the number of OFDM symbols included in the control region may be changed. A PDCCH (physical downlink control channel) and other control channels are allocated to the control region, and a PDSCH is allocated to the data region.

The physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

The PCFICH transmitted in the first OFDM symbol of the sub-frame carries CIF (control format indicator) regarding the number (i.e., size of the control region) of OFDM symbols used for transmission of control channels in the sub-frame. The wireless device first receives the CIF on the PCFICH and then monitors the PDCCH.

Unlike the PDCCH, the PCFICH is transmitted through a fixed PCFICH resource in the sub-frame without using blind decoding. The PHICH carries an ACK (positive-acknowledgement)/NACK (negative-acknowledgement) signal for a UL HARQ (hybrid automatic repeat request). The ACK/NACK signal for UL (uplink) data on the PUSCH transmitted by the wireless device is sent on the PHICH.

The PBCH (physical broadcast channel) is transmitted in the first four OFDM symbols in the second slot of the first sub-frame of the radio frame. The PBCH carries system information necessary for the wireless device to communicate with the base station, and the system information transmitted through the PBCH is denoted MIB (master information block). In comparison, system information transmitted on the PDSCH indicated by the PDCCH is denoted SIB (system information block).

The PDCCH may carry activation of VoIP (voice over internet protocol) and a set of transmission power control commands for individual UEs in some UE group, resource allocation of an upper layer control message such as a random access response transmitted on the PDSCH, system information on DL-SCH, paging information on PCH, resource allocation information of UL-SCH (uplink shared channel), and resource allocation and transmission format of DL-SCH (downlink-shared channel). A plurality of PDCCHs may be sent in the control region, and the terminal may monitor the plurality of PDCCHs. The PDCCH is transmitted on one CCE (control channel element) or aggregation of some consecutive CCEs. The CCE is a logical allocation unit used for providing a coding rate per radio channel's state to the PDCCH. The CCE corresponds to a plurality of resource element groups. Depending on the relationship between the number of CCEs and coding rates provided by the CCEs, the format of the PDCCH and the possible number of PDCCHs are determined.

The control information transmitted through the PDCCH is denoted downlink control information (DCI). The DCI may include resource allocation of PDSCH (this is also referred to as DL (downlink) grant), resource allocation of PUSCH (this is also referred to as UL (uplink) grant), a set of transmission power control commands for individual UEs in some UE group, and/or activation of VoIP (Voice over Internet Protocol).

The base station determines a PDCCH format according to the DCI to be sent to the terminal and adds a CRC (cyclic redundancy check) to control information. The CRC is masked with a unique identifier (RNTI; radio network temporary identifier) depending on the owner or purpose of the PDCCH. In case the PDCCH is for a specific terminal, the terminal's unique identifier, such as C-RNTI (cell-RNTI), may be masked to the CRC. Or, if the PDCCH is for a paging message, a paging indicator, for example, P-RNTI (paging-RNTI) may be masked to the CRC. If the PDCCH is for a system information block (SIB), a system information identifier, SI-RNTI (system information-RNTI), may be masked to the CRC. In order to indicate a random access response that is a response to the terminal's transmission of a random access preamble, an RA-RNTI (random access-RNTI) may be masked to the CRC.

In 3GPP LTE, blind decoding is used for detecting a PDCCH. The blind decoding is a scheme of identifying whether a PDCCH is its own control channel by demasking a desired identifier to the CRC (cyclic redundancy check) of a received PDCCH (this is referred to as candidate PDCCH) and checking a CRC error. The base station determines a PDCCH format according to the DCI to be sent to the wireless device, then adds a CRC to the DCI, and masks a unique identifier (this is referred to as RNTI (radio network temporary identifier) to the CRC depending on the owner or purpose of the PDCCH.

The uplink channels include a PUSCH, a PUCCH, an SRS (Sounding Reference Signal), and a PRACH (physical random access channel).

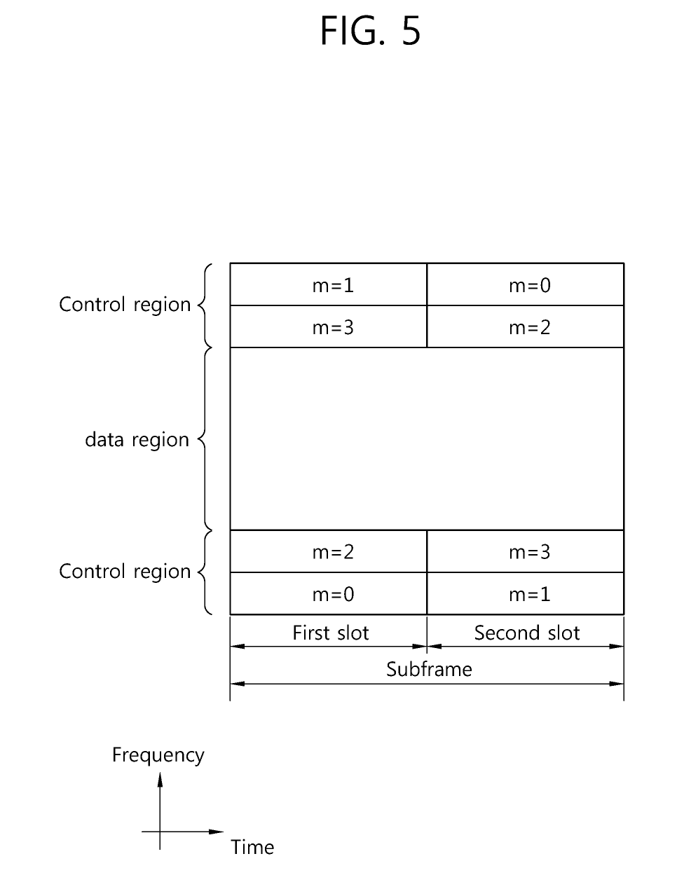

FIG. 5 Illustrates the Architecture of an Uplink Sub-Frame in 3GPP LTE.

Referring to FIG. 5, the uplink sub-frame may be separated into a control region and a data region in the frequency domain. The control region is assigned a PUCCH (physical uplink control channel) for transmission of uplink control information. The data region is assigned a PUSCH (physical uplink shared channel) for transmission of data (in some cases, control information may also be transmitted).

The PUCCH for one terminal is assigned in resource block (RB) pair in the sub-frame. The resource blocks in the resource block pair take up different sub-carriers in each of the first and second slots. The frequency occupied by the resource blocks in the resource block pair assigned to the PUCCH is varied with respect to a slot boundary. This is referred to as the RB pair assigned to the PUCCH having been frequency-hopped at the slot boundary.

The terminal may obtain a frequency diversity gain by transmitting uplink control information through different sub-carriers over time. m is a location index that indicates a logical frequency domain location of a resource block pair assigned to the PUCCH in the sub-frame.

The uplink control information transmitted on the PUCCH includes an HARQ (hybrid automatic repeat request), an ACK (acknowledgement)/NACK (non-acknowledgement), a CQI (channel quality indicator) indicating a downlink channel state, and an SR (scheduling request) that is an uplink radio resource allocation request.

The PUSCH is mapped with a UL-SCH that is a transport channel. The uplink data transmitted on the PUSCH may be a transport block that is a data block for the UL-SCH transmitted for the TTI. The transport block may be user information. Or, the uplink data may be multiplexed data. The multiplexed data may be data obtained by multiplexing the transport block for the UL-SCH and control information. For example, the control information multiplexed with the data may include a CQI, a PMI (precoding matrix indicator), an HARQ, and an RI (rank indicator). Or, the uplink data may consist only of control information.

<Carrier Aggregation: CA>

Hereinafter, a carrier aggregation system will be described.

The carrier aggregation (CA) system means aggregating multiple component carriers (CCs). By the carrier aggregation, the existing meaning of the cell is changed. According to the carrier aggregation, the cell may mean a combination of a downlink component carrier and an uplink component carrier or a single downlink component carrier.

Further, in the carrier aggregation, the cell may be divided into a primary cell, secondary cell, and a serving cell. The primary cell means a cell that operates at a primary frequency and means a cell in which the UE performs an initial connection establishment procedure or a connection reestablishment procedure with the base station or a cell indicated by the primary cell during a handover procedure. The secondary cell means a cell that operates at a secondary frequency and once an RRC connection is established, the secondary cell is configured and is used to provide an additional radio resource.

The carrier aggregation system may be divided into a continuous carrier aggregation system in which aggregated carriers are contiguous and a non-contiguous carrier aggregation system in which the aggregated carriers are separated from each other. Hereinafter, when the contiguous and non-contiguous carrier systems are just called the carrier aggregation system, it should be construed that the carrier aggregation system includes both a case in which the component carriers are contiguous and a case in which the component carriers are non-contiguous. The number of component carriers aggregated between the downlink and the uplink may be differently set. A case in which the number of downlink CCs and the number of uplink CCs are the same as each other is referred to as symmetric aggregation and a case in which the number of downlink CCs and the number of uplink CCs are different from each other is referred to as asymmetric aggregation.

When one or more component carriers are aggregated, the component carriers to be aggregated may just use a bandwidth in the existing system for backward compatibility with the existing system. For example, in a 3GPP LTE system, bandwidths of 1.4 MHz, 3 MHz, 5 MHz, 10 MHz, 15 MHz, and 20 MHz are supported and in a 3GPP LTE-A system, a wideband of 20 MHz or more may be configured by using only the bandwidths of the 3GPP LTE system. Alternatively, the wideband may be configured by not using the bandwidth of the existing system but defining a new bandwidth.

Meanwhile, in order to transmit/receive packet data through a specific secondary cell in the carrier aggregation, the UE first needs to complete configuration for the specific secondary cell. Herein, the configuration means a state in which receiving system information required for data transmission/reception for the corresponding cell is completed. For example, the configuration may include all processes that receive common physical layer parameters required for the data transmission/reception, media access control (MAC) layer parameters, or parameters required for a specific operation in an RRC layer. When the configuration-completed cell receives only information indicating that the packet data may be transmitted, the configuration-completed cell may immediately transmit/receive the packet.

The configuration-completed cell may be present in an activation or deactivation state. Herein, the activation transmitting or receiving the data or a ready state for transmitting or receiving the data. The UE may monitor or receive the control channel (PDCCH) and the data channel (PDSCH) of the activated cell in order to verify resources (a frequency, a time, and the like) assigned thereto.

The deactivation represents that transmitting or receiving traffic data is impossible or measurement or transmitting/receiving minimum information is possible. The UE may receive system information SI required for receiving the packet from the deactivated cell. On the contrary, the UE does not monitor or receive the control channel (PDCCH) and the data channel (PDSCH) of the deactivated cell in order to verify the resources (the frequency, the time, and the like) assigned thereto.

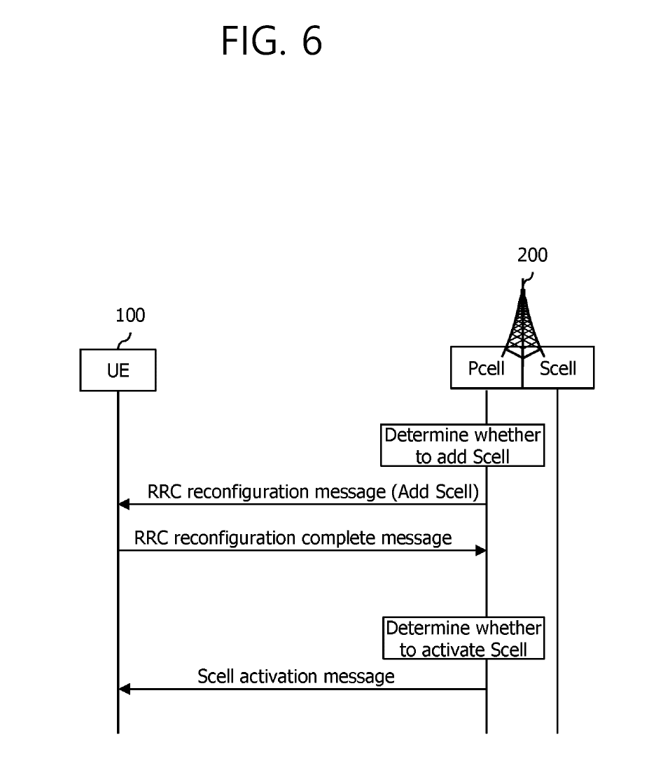

FIG. 6 Illustrates Inter-Cell Interference.

As illustrated in FIG. 6, when a UE 100 is located in an overlapping area of the coverage of a first cell 200a and the coverage of a second cell 200b, a signal of the first cell 200a acts as an interference with a second signal of the second cell 200b, while a signal of the second cell 200b acts as interference with a signal of the first cell 200a.

A basic method for addressing such an interference problem is using different frequencies for cells. However, since a frequency is a scarce and expensive resource, wireless service providers do not prefer a frequency division method.

Thus, the 3GPP employs a time division method to resolve the inter-cell interference problem.

Accordingly, the 3GPP has actively conducted studies on enhanced inter-cell interference coordination (eICIC) as an interference coordination method in recent years.

A time division method introduced in LTE-Release 10 has evolved as compared with a conventional frequency division method and thus is referred to as an enhanced ICIC. According to the time division method, an aggressor cell, which is a cell causing interference, suspends data transmission in a particular subframe so that a UE maintains connection to a victim cell, which is a cell undergoing the interference, in the subframe. That is, in the time division method, when different types of cells coexist, one cell temporarily suspends transmitting a signal to a UE having considerably high interference, thereby hardly sending an interference signal.

Meanwhile, the particular subframe in which data transmission is suspended is referred to as an almost blank subframe (ABS), in which no data is transmitted except for essential control data. The essential control data is, for example, a cell-specific reference signal (CRS). Therefore, not data but only CRSs are transmitted on OFDM symbols 0, 4, 7, and 11 in an ABS.

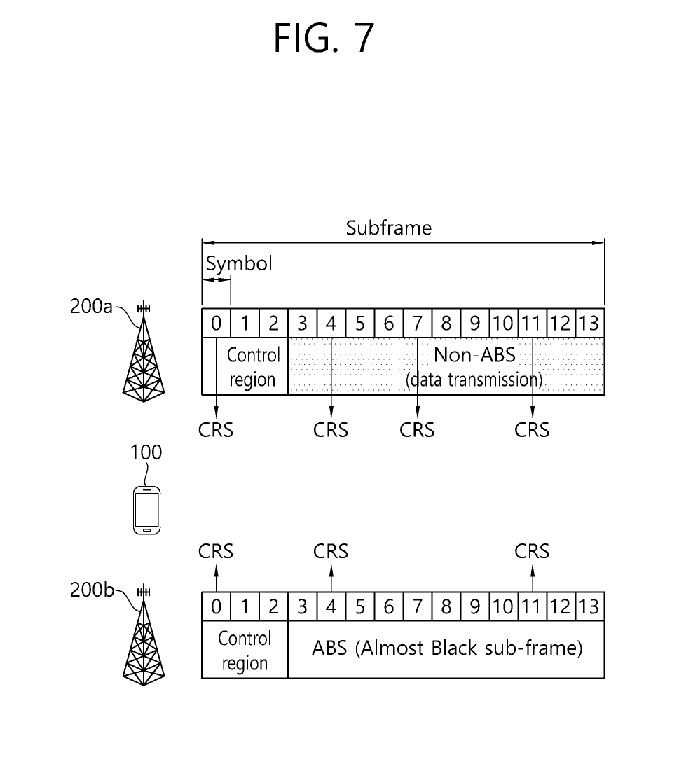

FIG. 7 Illustrates eICIC to Address Interference Between BSs.

Referring to FIG. 7, data transmission is performed via a data region of a subframe for a first cell 200a.

Here, a second cell 200b applies eICIC to address interference. That is, when the eICIC is applied, a corresponding subframe is managed as an ABS, so that no data may be transmitted via the data region.

In the subframe managed as the ABS, only CRSs may be transmitted on symbols 0, 4, 7, and 11.

<Introduction of Small Cell>

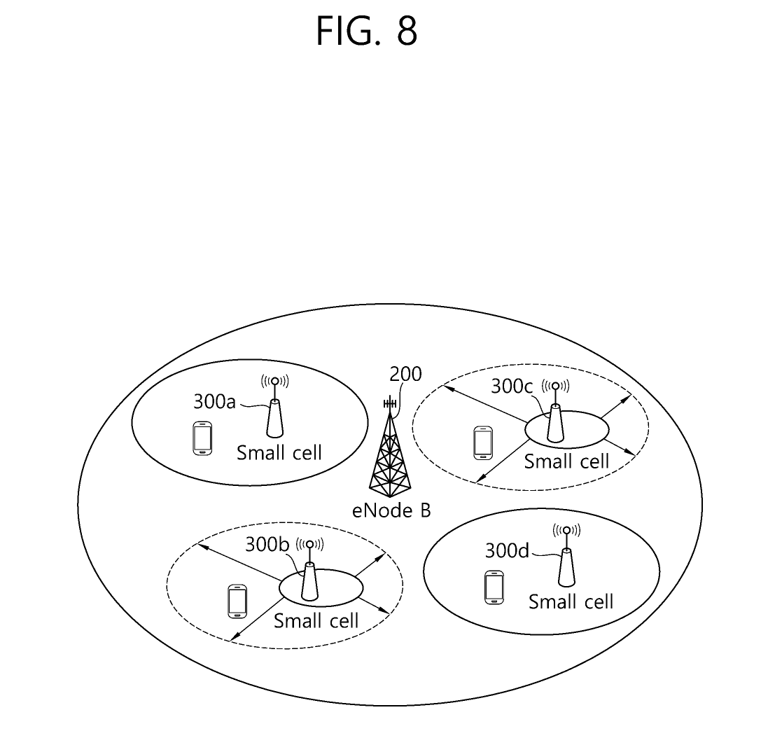

It is expected that small cells with small cell coverage are added to the coverage of an existing cell in a next-generation mobile communication system and deal with greater traffic. The existing cell has relatively larger coverage than the small cells and thus is referred to as a macrocell, which is described with reference to FIG. 8.

FIG. 8 Illustrates an Environment of a Heterogeneous Network Including a Macrocell and Small Cells as a Potential Next-Generation Wireless Communication System.

FIG. 8 shows a heterogeneous network environment in which a macrocell based on an existing BS 200 overlaps with small cells based on one or more small BSs 300a, 300b, 300c, and 300d. The existing BS provides relatively larger coverage than the small BSs and thus is also referred to as a macro BS (macro eNodeB: MeNB). In the present specification, a macrocell may be replaceable with a macro BS. A UE connected to the macrocell 200 may be referred to as a macro UE. The macro UE receives a downlink signal from the macro BS and transmits an uplink signal to the macro BS.

In this heterogeneous network, the macrocell is set as a primary cell (Pcell) and the small cells are set as secondary cells (Scell), thereby filling a gap in the macrocell coverage. Further, the small cells are set as primary cells (Pcell) and the macrocell is set as a secondary cell (Scell), thereby boosting overall performance.

The introduction of small cells, however, may aggravate inter-cell interference.

As described above, there may be a method of solving an inter-cell interference problem through an eICIC technique and a method in which a UE 100 performs reception through Interference Cancellation (hereinafter, referred to as “IC”).

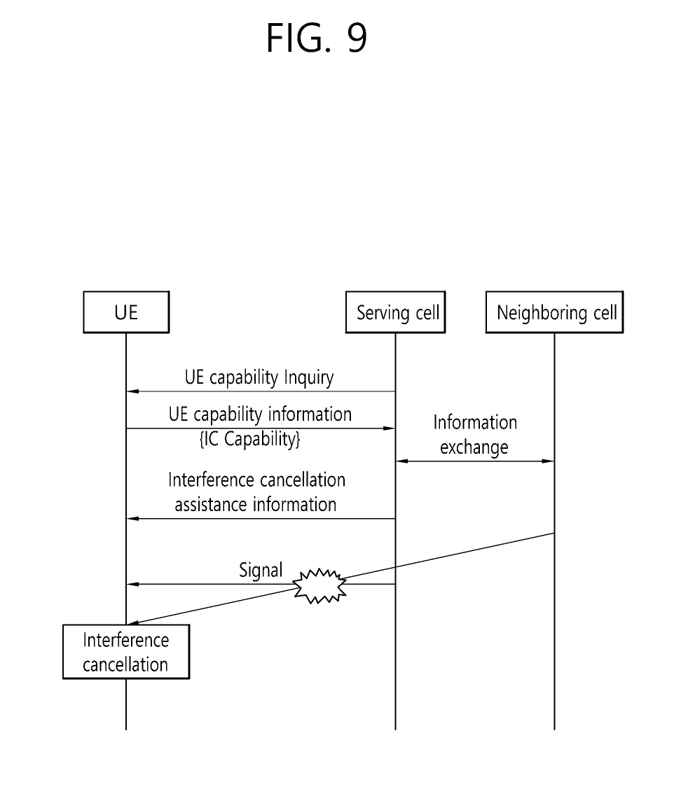

FIG. 9 is a signal flowchart illustrating a receiving method using interference cancellation.

A serving cell requests an UE performance inquiry to the UE 100 according to necessity or according to an instruction of a superordinate layer.

Accordingly, the UE 100 provides UE performance information according to the request. That is, the UE 100a notifies the serving cell through UE performance information that an eICIC function and an interference cancellation (IC) capability exist in response to the UE performance inquiry. Alternatively, when a radio access performance of the UE 100 is changed, a superordinate layer of the UE 100 may instruct a request for a performance inquiry to the superordinate layer of the serving cell.

The serving cell may determine whether a neighboring cell is an aggressor cell causing interference through information exchange with the neighboring cell. If a neighboring cell is an aggressor cell causing interference, the serving cell acquires information about a random channel of the neighboring cell.

Thereafter, when a signal to transmit to the UE 100 exists, the serving cell transmits interference cancellation assistance information including the acquired information about a random channel to the UE 100.

Thereafter, the serving cell transmits a signal to the UE 100.

In this case, when the signal transmitted by the serving cell is interfered by a signal transmitted by the neighboring cell, the UE 100 performs interference cancellation.

As described above, reception performed through Network Assisted Interference Cancellation and Suppression (NAICS) is referred to as Further Enhanced Inter-Cell Interference Coordination (FeICIC).

In this way, when an interference signal from the neighboring cell is cancelled, an SINR of a signal from the serving cell is more improved and thus a performance gain can be obtained.

A signal or a channel to be a target of interference cancellation may be a Cell-specific Reference Signal (CRS), a Physical Broadcasting Channel (PBCH), a Sync Channel (SCH), and a Physical downlink shared channel (PDSCH).

However, when a channel to be a target of interference cancellation (IC) is a PDSCH, an amount of interference cancellation assistance information in which the serving cell should provide to the UE may be too much. Therefore, when a channel to be a target of interference cancellation (IC) is a PDSCH, it may be efficient that the UE itself finds information necessary for interference cancellation.

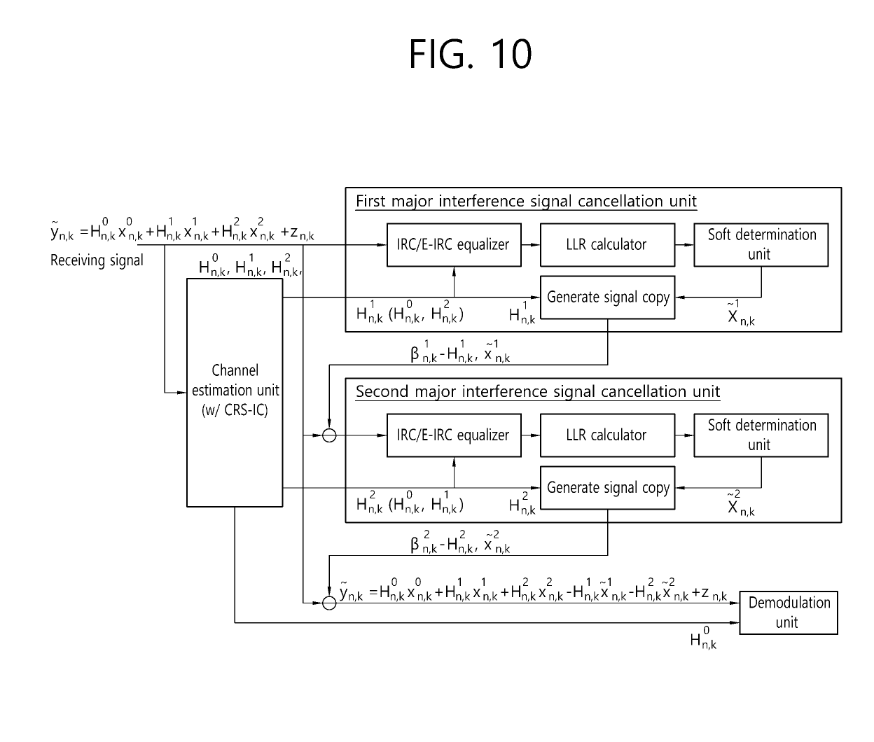

FIG. 10 is a diagram illustrating a structure of an interference cancellation receiver according to disclosure of this specification.

An IC receiver of FIG. 10 has a structure for cancelling an interference signal from a neighboring cell in a symbol level and includes a CRS interference cancellation function.

Specifically, the IC receiver of FIG. 10 includes a channel estimation unit, two interference signal cancellation units (i.e., a first major interference signal cancellation unit and a second interference cancellation receiving unit), and a demodulation unit. Here, it is assumed that two interference signal cancellation units are two interference sources (i.e., a neighboring cell causing interference). However, it should be noted that the present invention does not limit the number of neighboring cells causing interference to 2.

The first major interference signal cancellation unit and the second major interference signal cancellation unit each include an Interference Rejection Combining (Hereinafter, IRC)/Enhanced Interference Rejection Combining (Hereinafter, E-IRC) equalizer, a log-likelihood ratio (LLR) calculator, a soft determining unit, and a signal copy generator.

The IRC/E-IRC equalizer of the first major interference signal cancellation unit estimates a first major interference signal in a receiving signal based on a channel estimated by the channel estimation unit. Thereafter, a log-likelihood ratio is calculated by the LLR calculator, and a soft symbol is determined by the soft determining unit. The signal copy generator generates and outputs a signal copy using the estimated channel and the soft symbol.

The second major interference signal cancellation unit receives an input in which a signal copy generated by the first major interference signal cancellation unit is cancelled in the receiving signal. Accordingly, the IRC/E-IRC equalizer of the second major interference signal cancellation unit estimates a second major interference signal in the receiving signal based on a channel estimated by the channel estimation unit. Thereafter, a log-likelihood ratio is calculated by the LLR calculator, and a soft symbol is determined by the soft determining unit. The signal copy generator generates and outputs a signal copy using the estimated channel and the soft symbol.

The demodulation unit receives an input in which a signal copy generated by the second major interference signal cancellation unit is cancelled in the receiving signal.

The foregoing description will be mathematically described as follows.

When the number of neighboring cells causing interference is 2, the receiving signal is modeled as follows.

y_{n,k}=H_{n,k}⁰x_{n,k}⁰+H_{n,k}¹x_{n,k}¹+H_{n,k}²x_{n,k}²+z_{n,k} [Equation 1]

where H_{n,k}ⁱ represents a precoding channel.

Accordingly, the channel estimation unit of the IC receiver estimates a channel matrix of the first cell causing the first major interference using CRS transmitted from a first cell causing first major interference.

Thereafter, the IRC/E-IRC equalizer of the first major interference signal cancellation unit generates a weight matrix for a minimum mean square error (MMSE)-IRC of the first cell causing the first major interference using the estimated channel matrix and covariance matrix as follows.

$${w}_{n , k}^{i} = {( {\sum }_{{i}^{′} = 0}^{{N}_{cell}} {\tilde{{H}_{n , k}^{{i}^{′}}} ( {\tilde{H}}_{n , k}^{{i}^{′}} )}^{H} + {σ}_{z}^{2} I )}^{- 1} {( {\tilde{H}}_{n , k}^{i} )}^{H} \qquad [ Equation 2 ]$$

where n represents an n-th OFDM symbol, and k represents a k-th RE.

Thereafter, the IRC/E-IRC equalizer of the second major interference signal cancellation unit generates a weight matrix for MMSE-IRC of a second cell causing second major interference using the estimated channel matrix and covariance matrix as follows.

$${w}_{n , k}^{i} = {( {\sum }_{{i}^{′} = 0}^{{N}_{cell}} {β}_{n , k}^{{i}^{′}} {\tilde{{H}_{n , k}^{{i}^{′}}} ( {\tilde{H}}_{n , k}^{{i}^{′}} )}^{H} + {σ}_{z}^{2} I )}^{- 1} {( {\tilde{H}}_{n , k}^{i} )}^{H} \qquad [ Equation 3 ]$$

where β_{n,k}¹ is a regenerated signal change amount after mapping a soft symbol for interference cancellation and is represented as follows.

$${β}_{n , k}^{i} = {\sum }_{x ∈ Ω} {\vert x \vert}^{2} Pr ( {x}_{n , k}^{i} = x ) - {\vert {\tilde{x}}_{n , k}^{i} \vert}^{2} \\ {\tilde{x}}_{n , k}^{i} = {\sum }_{x ∈ Ω} xPr ( {x}_{n , k}^{i} = x ) \qquad [ Equation 4 ]$$

where

$${\tilde{x}}_{n , k}^{i}$$

is a soft symbol.

Because an interference cancellation receiver of a symbol level among NAICS receivers that can cancel an adjacent cell interference signal has very large complexity, it may be inefficient to always perform interference cancellation.

In order to solve this, it may be most easily considered that a network transmits an indicator on operation of an interference cancellation receiver of a symbol level to a UE. However, even if signaling from the network is UE-specific signaling, in consideration of inaccuracy of transmission that may occur in a delay and signal transmitting process of the network, when interference is in a dynamic environment, there is a limitation to simply depend to only signaling from the network. Particularly, because the UE rather than the network more accurately determines in real time information about an interference cell environment, it may be inefficient to simply depend to only signaling from the network.

<Disclosure of this Specification>

Therefore, in order to solve the foregoing problem, this specification provides a method of enabling a UE itself to turn on/off interference cancellation of a symbol level performed under network assistance. In this way, in order for the UE itself to turn on/off interference cancellation of a symbol level, an additional device should exist within the interference cancellation receiver of the UE. The device may be variously changed according to receiving algorithm in which the UE uses for interference cancellation.

Hereinafter, a method of determining whether the UE turns on/off interference cancellation of a symbol level according to any one of a power level, the rank number of an interference cell, a modulation order of the interference cell, and a TM of the interference cell and a serving cell will be described.

1. Method of Determining Whether to Turn on/Off Interference Cancellation of a Symbol Level According to a Power Level

By comparing receiving power from the serving cell and receiving power from the interference cell, when receiving power from the interference cell is equal to or larger than receiving power from the serving cell by a predetermined ratio, i.e., only when a signal-to-interference ratio (SIR)<=a threshold value, in order to cancel interference of an adjacent cell, interference cancellation is turned on. However, when an SIR>=a threshold value, even if interference cancellation is performed, there is a high possibility that enhancement of a reception performance from the serving cell may not be large. Therefore, for interference cancellation of NAICS, it is advantageous to perform operation by falling back with existing MMSE-IRC or Enhanced MMSE-IRC (EMMSE-IRC) rather than to perform a complex operation.

2. Method of Determining Whether to Turn on/Off Interference Cancellation of a Symbol Level According to the Rank Number of an Interference Cell

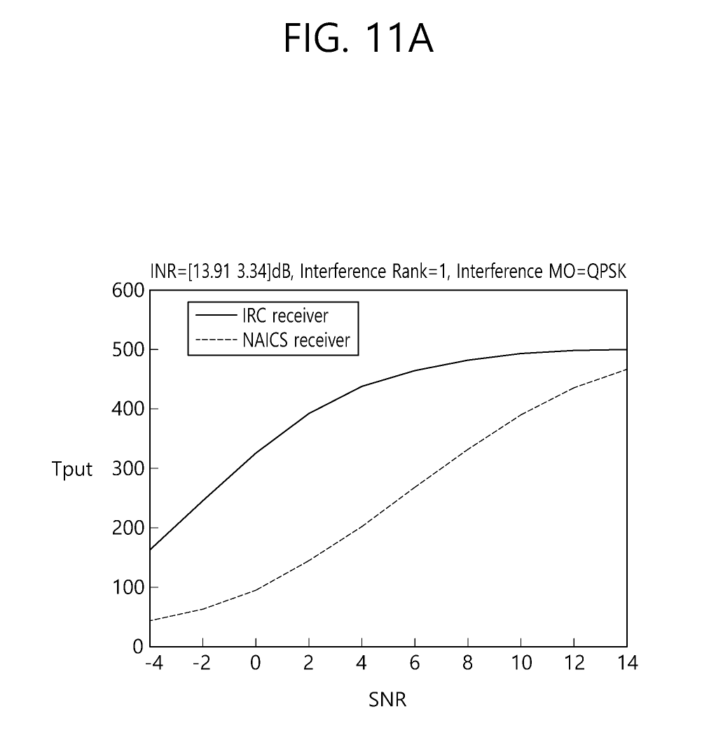

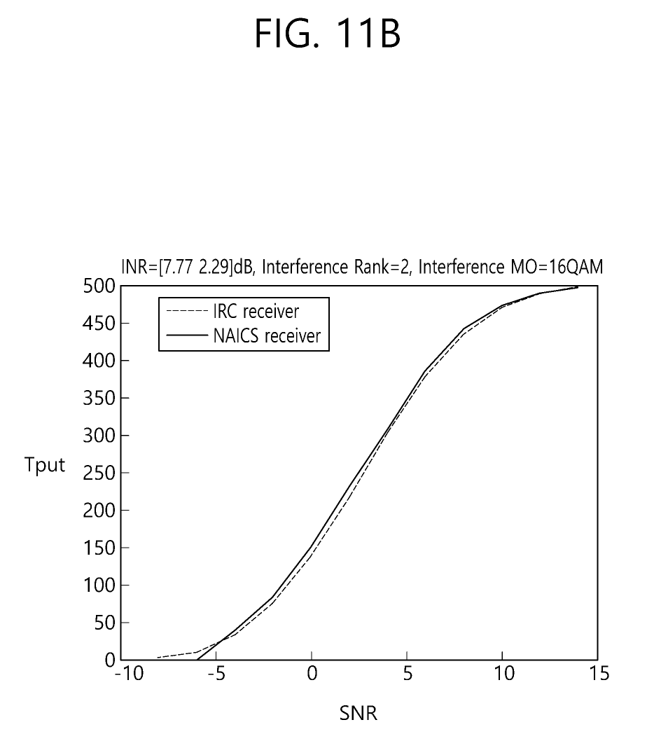

In order to determine whether to turn on/off interference cancellation according to the rank number of the interference cell, an inventor of the present invention performed a simulation. A result thereof is illustrated in FIGS. 11A and 11B.

FIG. 11A is a graph comparing a performance of a NAICS receiver and a performance of a general IRC receiver, when a rank of an interference cell is 1, and FIG. 11B is a graph comparing a performance of a NAICS receiver and a performance of a general IRC receiver, when a rank of an interference cell is 2.

As can be seen with reference to FIG. 11A, when the rank number of a major interference cell is 1 and when INR is large, a performance of the NAICS receiver is superior to that of a general IRC receiver.

However, as can be seen with reference to FIG. 11B, when the rank number of a major interference cell is 2 and when INR is small, a performance of the NAICS receiver is almost similar to that of a general IRC receiver. That is, a blind decoding performance of a precoding matrix when the rank number of a major interference cell is 2 and when the interference cell operates with a CRS based TM is lower than that when the rank number of a major interference cell is 1.

Therefore, when determining whether the interference cancellation receiver of the UE should perform blind detection of interference data, if a rank of an interference cell is 2 or more, it is efficient to perform operation by falling back with MMSE-IRC or EMMSE-IRC rather than to operate the NAICS receiver within the UE and to perform a complex operation for interference cancellation.

3. Method of Determining Whether to Turn on/Off Interference Cancellation of a Symbol Level According to a Modulation Order of an Interference Cell

When a modulation order of the interference cell is a predetermined reference, for example 16 QAM or more, a performance gain by NAICS may not be large due to an error by blind detection of a modulation order. In this case, whether to operate NAICS may be determined according to a condition of a power difference between the interference cell and a serving cell and the rank number of an interference cell.

That is, in a case in which a MO of the interference cell is 16QAM or more, only when the following condition is satisfied, it may be considered to turn on NAICS.

random function(delta RSRP,Rank_{interf},TM_{combo},MO)>threshold value

Here, delta RSRP=RSRP_{serving cell}−RSRP_{interfering cell}, and Rank_{interf} is the number of layers or ranks of the interference cell, TM_{combo} is a TM combination between the serving cell and the interference cell, and the MO may be defined to 2 when the MO is QPSK as a modulation order of the interference cell, may be defined to 4 when the MO is 16QAM, and may be defined to 8 when the MO is 64QAM.

4. Method of Determining Whether to Turn on/Off Interference Cancellation of a Symbol Level According to a TM of the Interference Cell and the Serving Cell

The UE performs CRS interference cancellation (CRS-IC) and DMRS interference cancellation (DMRS-IC) and performs CRS or DMRS based channel estimation, thereby enhancing a reception performance. However, when the serving cell uses a DMRS based TM (e.g., TM8 or TM9) and when the interference cell uses a CRS based TM (e.g., TM2, TM3, TM4 or TM6), in order to know a performance, the inventor of the present invention performed an experiment.

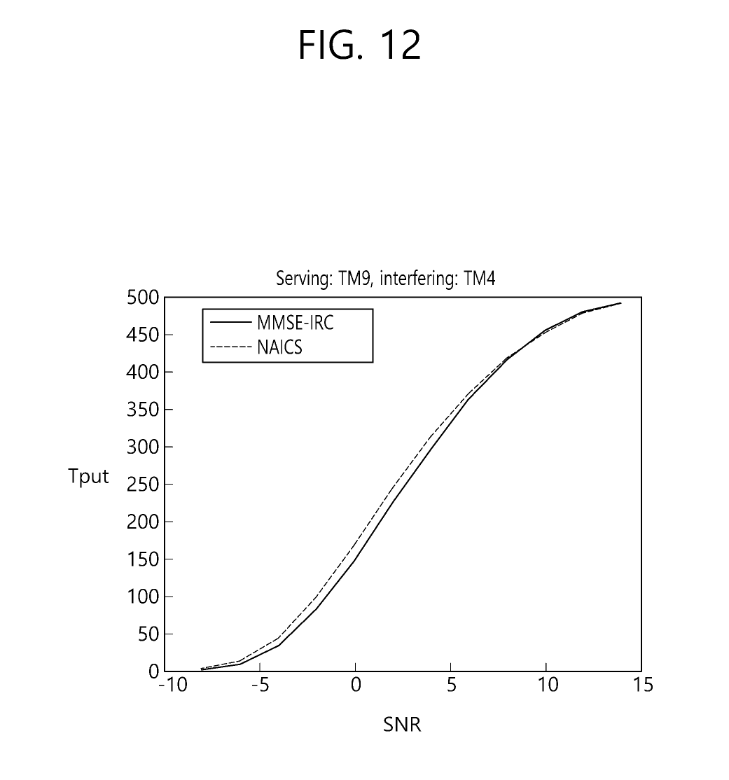

FIG. 12 is a graph illustrating a performance of NAICS and a performance of existing MMSE-IRC, when the serving cell uses TM9 and when the interference cell uses TM4.

For example, when the serving cell uses TM9 and when the interference cell uses TM4, a performance of DMRS based channel estimation of the serving cell is deteriorated due to an influence by interference data to have an influence on a reception performance. In this case, even if interference data are cancelled, a channel estimation value of the serving cell used for the NAICS receiver uses a value before cancelling interference data and thus as shown in FIG. 12, it is difficult to obtain a performance gain of the NAICS receiver. Therefore, in an environment in which the TM is mixedly used, i.e., in a situation in which the serving cell uses a DMRS based TM and in which the serving cell uses a CRS based TM, it is efficient to perform operation by falling back with MMSE-IRC or EMMSE-IRC rather than to perform a complex operation in order to operate the NAICS receiver within the UE and to cancel interference.

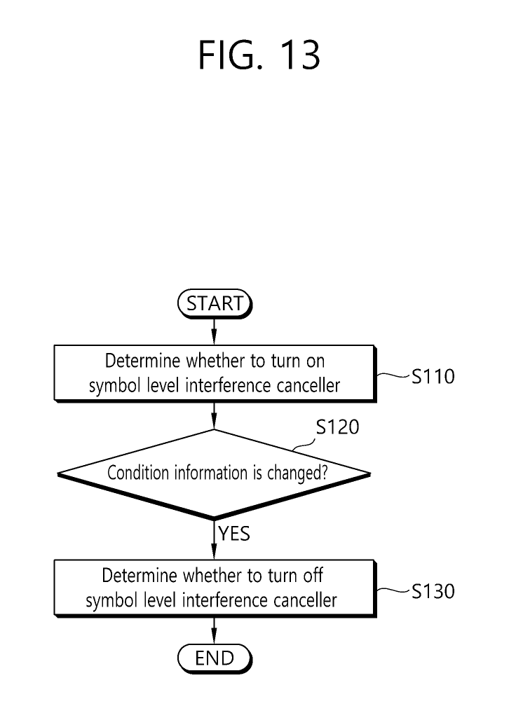

FIG. 13 is a flowchart illustrating a method according to disclosure of this specification.

As can be seen with reference to FIG. 13, the UE may determine whether to turn on a symbol level interference canceller based on condition information about any one of the serving cell and the interference cell (S110). The UE may operate the symbol level interference canceller according to the determination.

If the condition information is changed (S120) while operating the symbol level interference canceller, the UE may determine whether to turn off the symbol level interference canceller.

As described, exemplary embodiments of the present invention may be implemented through various means. For example, exemplary embodiments of the present invention may be implemented by hardware, firmware, software, or a combination thereof. Specifically, exemplary embodiments of the present invention will be described with reference to the drawings.

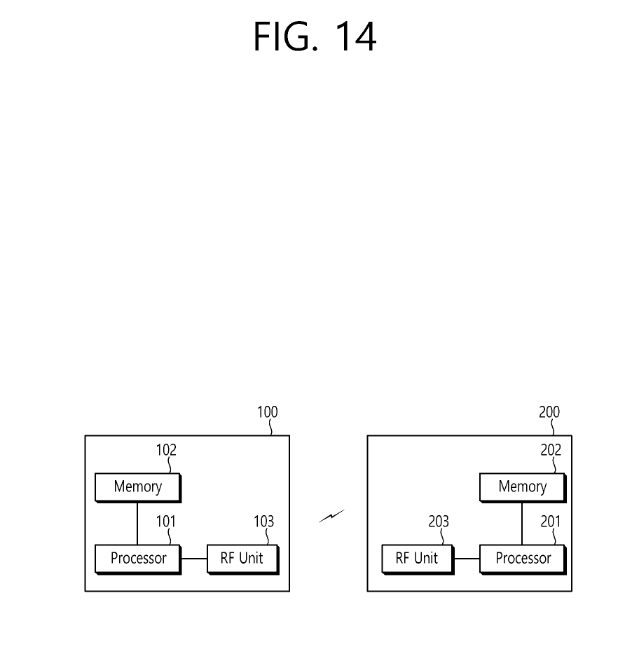

FIG. 14 is a block diagram illustrating a wireless communication system according to disclosure of this specification.

A base station 200 includes a processor 201, a memory 202, and a radio frequency (RF) unit 203. The memory 202 is connected to the processor 201 to store various information for driving the processor 201. The RF unit 203 is connected to the processor 201 to transmit and/or receive a wireless signal. The processor 201 implements a suggested function, process, and/or method. In the foregoing exemplary embodiment, operation of the base station may be implemented by the processor 201.

An UE 100 includes a processor 101, a memory 102, and an RF unit 103. The memory 102 is connected to the processor 101 to store various information for driving the processor 101. The RF unit 103 is connected to the processor 101 to transmit and/or receive a wireless signal. The processor 101 implements a suggested function, process, and/or method.

The processor may include an application-specific integrated circuit (ASIC), another chipset, a logic circuit and/or a data processor. The memory may include a read-only memory (ROM), a random access memory (RAM), a flash memory, a memory card, a storage medium, and/or another storage device. The RF unit may include a baseband circuit for processing a wireless signal. When an exemplary embodiment is implemented with software, the above-described technique may be implemented with a module (process, function) that performs the above-described function. The module may be stored at a memory and may be executed by the processor. The memory may exist at the inside or the outside of the processor and may be connected to the processor with well-known various means.

In the above illustrated systems, although the methods have been described on the basis of the flowcharts using a series of steps or blocks, the present invention is not limited to the sequence of the steps, and some of the steps may be performed with different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for determining whether to operate a symbol level interference canceller based on network assistance, the method comprising:
determining whether to turn on the symbol level interference canceller based on condition information about any one of a serving cell and an interference cell;
operating the symbol level interference canceller according to the determination; and
determining whether to turn off the symbol level interference canceller, when the condition information is changed while operating the symbol level interference canceller.

2. The method of claim 1, wherein the condition information about any one of a serving cell and an interference cell includes at least one of:
condition information about receiving power from the serving cell and receiving power from the interference cell;
condition information about the rank number of the interference cell;
condition information about a modulation order of the interference cell; and
information about a transmission mode (TM) of the serving cell and condition information about a TM of the interference cell.

3. The method of claim 2, wherein the determining of whether to turn on the symbol level interference canceller comprises determining to turn on the symbol level interference canceller, if receiving power from the interference cell is equal to or larger than receiving power from the serving cell by a predetermined ratio, and
the determining of whether to turn off the symbol level interference canceller comprises determining to turn off the symbol level interference canceller, if receiving power from the interference cell is smaller than receiving power from the serving cell by a predetermined ratio.

4. The method of claim 2, wherein the determining of whether to turn on the symbol level interference canceller comprises determining to turn on the symbol level interference canceller, when a rank of the interference cell is 1, and
the determining of whether to turn off the symbol level interference canceller comprises determining to turn off the symbol level interference canceller, when a rank of the interference cell is 2.

5. The method of claim 2, wherein the determining of whether to turn on the symbol level interference canceller and the determining of whether to turn off the symbol level interference canceller are performed when a modulation order of the interference cell is equal to or larger than a predetermined modulation order.

6. The method of claim 2, wherein the determining of whether to turn on the symbol level interference canceller comprises determining to turn on the symbol level interference canceller, when the serving cell and the interference cell equally use a CRS or DMRS based TM, and
the determining of whether to turn off the symbol level interference canceller comprises determining to turn off the symbol level interference canceller when the serving cell uses a DMRS based TM, but when the interference cell uses a CRS based TM.

7. A user device, comprising:
a radio frequency (RF) unit comprising a symbol level interference cancellation receiver;
a processor that controls the RF unit,
wherein the processor determines whether to turn on the symbol level interference canceller based on condition information about any one of a serving cell and an interference cell, operates the symbol level interference canceller according to the determination, and determines whether to turn off the symbol level interference canceller, when the condition information is changed while operating the symbol level interference canceller.

8. The user device of claim 7, wherein the condition information about any one of a serving cell and an interference cell comprises at least one of:
condition information about receiving power from the serving cell and receiving power from the interference cell;
condition information about the rank number of the interference cell;
condition information about a modulation order of the interference cell; and
information about a transmission mode (TM) of the serving cell and condition information about a transmission mode of the interference cell.
